(19) United States
(12) Patent Application Publication
(10) Pub. No.: US 2006/0114169 A1
(43) Pub. Date: Jun. 1, 2006

(54) Low cost satellite communication components manufactured from conductively doped resin-based materials

(75) Inventor: Thomas Aisenbrey, Littleton, CO (US)

Correspondence Address: GEORGE O. SAILE, 28 DAVIS AVENUE, POUGHKEEPSIE, NY, 12603, US

(73) Assignee: Integral Technologies, Onc.

(21) Appl. No.: 11/328,553

(22) Filed: Jan. 10, 2006

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/642,752, filed on Jan. 10, 2005.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. H01Q 19/12

(52) U.S. Cl. 343/840

(57) ABSTRACT

Satellite antenna devices are formed of a conductively doped resin-based material. The conductively doped resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductively doped resin-based material. The micron conductive powders are metals or conductive non-metals or metal plated non-metals. The micron conductive fibers may be metal fiber or metal plated fiber. Further, the metal plated fiber may be formed by plating metal onto a metal fiber or by plating metal onto a non-metal fiber. Any platable fiber may be used as the core for a non-metal fiber. Superconductor metals may also be used as micron conductive fibers and/or as metal plating onto fibers in the present invention.

### RELATED PATENT APPLICATIONS

This Patent Application claims priority to the U.S. Provisional Patent Application 60/642,752 filed on Jan. 10, 2005, which is herein incorporated by reference in its entirety.

This Patent Application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, now issued as U.S. Pat. No. 6,870,516, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### BACKGROUND OF THE INVENTION

(1) Field of the Invention

This invention relates to satellite communications and, more particularly, to satellite communication antennas molded of conductively doped resin-based materials comprising micron conductive powders, micron conductive fibers, or a combination thereof, substantially homogenized within a base resin when molded. This manufacturing process yields a conductive part or material usable within the EMF, thermal, acoustic, or electronic spectrum(s)

(2) Description of the Prior Art

Satellite communication systems have gained wide acceptance in the marketplace. Television and radio broadcasting and data networks are now carried over satellite communication systems. In a satellite-based system, a communication signal is transmitted into space to an orbiting satellite. A transponder on the satellite re-transmits the signal back to earth where it can be received anywhere across a large geographical region. Unlike traditional telephone and cable television systems, satellite systems do not require physical wiring networks. In addition, satellite systems can reach an unlimited number of sites, regardless of location. Unlike cellular telephones systems, satellite systems can provide global-level coverage, with digital quality, even in the most remote areas.

Most commercial satellites are positioned to orbit in a geostationary arc. Geostationary satellites orbit around the Earth's equatorial plane at the same velocity as that of the rotating surface of the earth. Therefore, these satellites appear to remain in a fixed orbital slot in the sky. A stationary receiving antenna can therefore be permanently aimed toward a targeted geostationary satellite.

An important component in any satellite-based communication system is the antenna. Antennas are used to receive and to transmit electromagnetic energy. Digital or analog information, such as video or audio data, is first encoded and/or modulated first onto an electrical voltage or current signal. This electrical signal is then driven onto an antenna. The oscillating electrical signal on the antenna generates a corresponding electromagnetic signal that radiates away from the antenna. This electromagnetic energy propagates as electric and magnetic waves. Electromagnetic waves are characterized by their oscillating frequency that is inversely proportional to signal wavelength. High frequency signals have short wavelengths, and low frequency signals have long wavelengths. In a typical satellite system, the electromagnetic signal sent from the transmitting ground station, called the up-link signal, is a high frequency, microwave signal. At the orbiting satellite, the up-link signal is received by an antenna. The electromagnetic wave energy induces electrical voltage and current in the receiving antenna that corresponds to the original electrical voltage and current in the ground transmitter. A transponder circuit is used to modulate the up-link signal into the desired down-link frequency. The transponder then re-transmits the signal, using another antenna, as a signal broadcast toward the Earth below. This down-link signal can be received anywhere within the ground coverage of the orbiting satellite. Ground coverage areas can be as large as 40% of the Earth's service. Therefore, the satellite system provides an excellent method to provide communications coverage over a broad area without the need for extensive wiring or cellular antenna networks.

Satellite systems typically use extremely high frequencies that are classified as microwaves due to the short wavelengths. Microwave energy is capable of traveling thousands of miles through the atmosphere between an orbiting satellite and the Earth without signal degradation. As the signal travels, it tends to spread or diffuse. In the case of a down-link signal, this spreading is by design so that a large coverage area is achieved. As a result, the electromagnetic signal that reaches a ground antenna is typically very weak. For example, the power of a satellite signal received by a ground antenna is typically 10⁻¹⁴ watts/m² or less. Therefore, a means for concentrating satellite signals onto a receiving antenna is typically required. For similar reasons, transmitted signals are concentrated as much as possible to assure that the strongest possible signal is generated.

To facilitate signal concentration, many satellite antennas incorporate a signal reflection device into the antenna design. A parabolic shaped reflector, typically called a dish, is used to achieve signal concentration. Electromagnetic waves incident upon a parabolic reflector, along the reflector's axis of symmetry, are reflected toward a common focal point. A parabolic reflector concentrates electromagnetic energy arriving across the dish area into a smaller focal point to effect a concentration of energy. Further, this concentration of energy is achieved without altering the phase relationship in the signal energy. This concentrated energy is then typically channeled through a feed horn and/or waveguide where energy is further concentrated and is protected from external electromagnetic energy interference until the energy is presented to an antenna probe. The antenna probe converts the received electromagnetic signal into an electrical signal for further processing. In the case of a transmitting satellite antenna, the process is reversed. An electrical signal is driven onto an antenna to generated electromagnetic waves. These waves are then channeled though a waveguide to the focal point of a parabolic reflector. The electromagnetic waves then reflect off the parabolic reflector as a beam of waves traveling along the reflector's axis of symmetry.

To properly concentrate received signals or to focus transmit beams, the parabolic-shaped reflector, the feed-horn, the waveguide, and the probe antenna must work in harmony. The reflector must have a surface that is smooth and that comprises a material that is efficiently reflective of microwave energy. The reflector must be shaped to tight tolerances and must maintain shape over large changes in temperature, over many thermal cycles, and in spite of difficult environmental factors. The feed horn and waveguide have similar requirements for precise manufacture and field stability. The antenna must be constructed to oscillate easily with microwave energy. In addition, the reflector, feed horn, waveguide, and probe antenna must maintain relative orientation to the orbiting satellite and to one-another. It is a principle object of the present invention to provide novel satellite communications antennas with excellent performance through the incorporation of a novel conductively doped resin-based material.

Several prior art inventions relate to satellite antenna systems and components. U.S. Pat. No. 6,172,650 B1 to Ogawa et al teaches an antenna system suitable for in-vehicle satellite tracking. The antenna comprises a feed probe, a main reflector, a sub-reflector, and a ground plate. The ground plate may comprise a conductive plastic. U.S. Patent Application 2004/0009728 A1 to Kubomura et al teaches a composite material comprising a laminated body impregnated with resin and having two tri-axial woven fabrics and an electrically conductive non-woven fabric. The electrically conductive non-woven fabric contains metal fibers or is metal plated. This composite laminated material is used to form a reflector of a parabolic antenna receiver for use in 12 GHZ band communications. U.S. Pat. No. 6,100,851 to Jones describes a satellite antenna system with a heating mechanism to prevent ice or snow build-up on the reflector.

### SUMMARY OF THE INVENTION

A principal object of the present invention is to provide an effective satellite communications antenna.

A further object of the present invention is to provide a method to form a satellite communications device.

A further object of the present invention is to provide a satellite communications antenna molded of conductively doped resin-based materials.

A yet further object of the present invention is to provide a satellite communications antenna molded of conductively doped resin-based material where the electromagnetic characteristics can be altered or the visual characteristics can be altered by forming a metal layer over the conductively doped resin-based material.

A yet further object of the present invention is to provide methods to fabricate a satellite communications antenna from a conductively doped resin-based material incorporating various forms of the material.

A yet further object of the present invention is to provide a method to fabricate a satellite communications antenna from a fabric form of conductively doped resin-based material.

A further object of the present invention is to provide a satellite communications antenna from a low density material that, nonetheless, exhibits excellent structural strength and excellent antenna performance.

A further object of the present invention is to provide a satellite communications antenna with excellent corrosion resistance.

A further object of the present invention is to provide a reflector for a satellite communications antenna.

A further object of the present invention is to provide a feed horn for a satellite communications antenna.

A further object of the present invention is to provide a waveguide for a satellite communications antenna.

A further object of the present invention is to provide a low noise band circuit for a satellite communications antenna.

In accordance with the objects of this invention, a satellite antenna device is achieved. The device comprises a reflector and an antenna mounted near the reflector such that electromagnetic energy is transferred between the reflector and the antenna. The antenna comprises conductively doped, resin-based material comprising conductive materials in a base resin host.

Also in accordance with the objects of this invention, a satellite antenna device is achieved. The device comprises a reflector and an antenna mounted near the reflector such that electromagnetic energy is transferred between the reflector and the antenna. The antenna and the reflector comprise conductively doped, resin-based material comprising micron conductive fiber in a base resin host.

Also in accordance with the objects of this invention, a method to form a satellite antenna device is achieved. The method comprises providing a conductively doped, resin-based material comprising conductive materials in a resin-based host. The conductively doped, resin-based material is molded into a satellite antenna device comprising a reflector and an antenna mounted near the reflector such that electromagnetic energy is transferred between the reflector and the antenna. The antenna comprises the conductively doped, resin-based material.

### BRIEF DESCRIPTION OF THE DRAWINGS

In the accompanying drawings forming a material part of this description, there is shown:

FIG. 1 illustrates an embodiment of the present invention showing a satellite antenna device comprising conductively doped resin-based material.

FIG. 2 illustrates an embodiment of a conductively doped resin-based material wherein the conductive materials comprise a powder.

FIG. 3 illustrates an embodiment of a conductively doped resin-based material wherein the conductive materials comprise micron conductive fibers.

FIG. 4 illustrates an embodiment of a conductively doped resin-based material wherein the conductive materials comprise both conductive powder and micron conductive fibers.

FIGS. 5a and 5b illustrate an embodiment wherein conductive fabric-like materials are formed from the conductively doped resin-based material.

FIGS. 6a and 6b illustrate, in simplified schematic form, an injection molding apparatus and an extrusion molding apparatus that may be used to mold satellite communication components of a conductively doped resin-based material.

FIG. 7 illustrates an embodiment of the present invention showing a satellite antenna device comprising conductively doped resin-based material.

FIG. 8 illustrates an embodiment of the present invention showing a marine satellite radio antenna comprising conductively doped resin-based material.

FIG. 9 illustrates an embodiment of the present invention showing an exterior home satellite radio antenna comprising conductively doped resin-based material.

FIG. 10 illustrates an embodiment of the present invention showing a low profile automobile satellite radio antenna comprising conductively doped resin-based material.

FIG. 11 illustrates an embodiment of the present invention showing an end view of a feed horn comprising conductively doped resin-based material.

FIG. 12 illustrates an embodiment of the present invention showing an assembly combining feed horn, wave guide, and low noise block down-converter.

### DESCRIPTION OF THE PREFERRED EMBODIMENTS

This invention relates to satellite communication devices molded of conductively doped resin-based materials comprising micron conductive powders, micron conductive fibers, or a combination thereof, substantially homogenized within a base resin when molded.

The conductively doped resin-based materials of the invention are base resins doped with conductive materials to convert the base resin from an insulator to a conductor. The base resin provides structural integrity to the molded part. The doping material, such as micron conductive fibers, micron conductive powders, or a combination thereof, is substantially homogenized within the resin during the molding process. The resulting conductively doped resin-based material provides electrical, thermal, and acoustical continuity.

The conductively doped resin-based materials can be molded, extruded or the like to provide almost any desired shape or size. The molded conductively doped resin-based materials can also be cut, stamped, or vacuumed formed from an injection molded or extruded sheet or bar stock, over-molded, laminated, milled or the like to provide the desired shape and size. The thermal, electrical, and acoustical continuity and/or conductivity characteristics of articles or parts fabricated using conductively doped resin-based materials depend on the composition of the conductively doped resin-based materials. The type of base resin, the type of doping material, and the relative percentage of doping material incorporated into the base resin can be adjusted to achieve the desired structural, electrical, or other physical characteristics of the molded material. The selected materials used to fabricate the articles or devices are substantially homogenized together using molding techniques and or methods such as injection molding, over-molding, insert molding, compression molding, thermo-set, protrusion, extrusion, calendaring, or the like. Characteristics related to 2D, 3D, 4D, and 5D designs, molding and electrical characteristics, include the physical and electrical advantages that can be achieved during the molding process of the actual parts and the molecular polymer physics associated within the conductive networks within the molded part(s) or formed material(s).

In the conductively doped resin-based material, electrons travel from point to point, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive doping concentration and material makeup, that is, the separation between the conductive doping particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductively doped resin-based material are altered when molded into a structure. A substantially homogenized conductive microstructure of delocalized valance electrons is created within the valance and conduction bands of the molecules. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

Conductively doped resin-based materials lower the cost of materials and of the design and manufacturing processes needed for fabrication of molded articles while maintaining close manufacturing tolerances. The molded articles can be manufactured into infinite shapes and sizes using conventional forming methods such as injection molding, over-molding, compression molding, thermoset molding, or extrusion, calendaring, or the like. The conductively doped resin-based materials, when molded, typically but not exclusively produce a desirable usable range of resistivity of less than about 5 to more than about 25 ohms per square, but other resistivities can be achieved by varying the dopant(s), the doping parameters and/or the base resin selection(s).

The conductively doped resin-based materials comprise micron conductive powders, micron conductive fibers, or any combination thereof, which are substantially homogenized together within the base resin, during the molding process, yielding an easy to produce low cost, electrical, thermal, and acoustical performing, close tolerance manufactured part or circuit. The resulting molded article comprises a three dimensional, continuous capillary network of conductive doping particles contained and or bonding within the polymer matrix. Exemplary micron conductive powders include carbons, graphites, amines, eeonomers, or the like, and/or of metal powders such as nickel, copper, silver, aluminum, nichrome, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. Carbon nano-tubes may be added to the conductively doped resin-based material. The addition of conductive powder to the micron conductive fiber doping may improve the electrical continuity on the surface of the molded part to offset any skinning effect that occurs during molding.

The micron conductive fibers may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fibers include, but are not limited to, carbon, graphite, polyester, basalt, melamine, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

Where micron fiber is combined with base resin, the micron fiber may be pretreated to improve performance. According to one embodiment of the present invention, conductive or non-conductive powders are leached into the fibers prior to extrusion. In other embodiments, the fibers are subjected to any or several chemical modifications in order to improve the fibers interfacial properties. Fiber modification processes include, but are not limited to: chemically inert coupling agents; gas plasma treatment; anodizing; mercerization; peroxide treatment; benzoylation; or other chemical or polymer treatments.

Chemically inert coupling agents are materials that are molecularly bonded onto the surface of metal and or other fibers to provide surface coupling, mechanical interlocking, inter-difussion and adsorption and surface reaction for later bonding and wetting within the resin-based material. This chemically inert coupling agent does not react with the resin-based material. An exemplary chemically inert coupling agent is silane. In a silane treatment, silicon-based molecules from the silane bond to the surface of metal fibers to form a silicon layer. The silicon layer bonds well with the subsequently extruded resin-based material yet does not react with the resin-based material. As an additional feature during a silane treatment, oxane bonds with any water molecules on the fiber surface to thereby eliminate water from the fiber strands. Silane, amino, and silane-amino are three exemplary pre-extrusion treatments for forming chemically inert coupling agents on the fiber.

In a gas plasma treatment, the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion, improving wetting during homogenization, and/or reducing oxide growth (when compared to non-treated fiber). Pretreatment fiber modification also reduces levels of particle dust, fines, and fiber release during subsequent capsule sectioning, cutting or vacuum line feeding.

The resin-based structural material may be any polymer resin or combination of compatible polymer resins. Non-conductive resins or inherently conductive resins may be used as the structural material. Conjugated polymer resins, complex polymer resins, and/or inherently conductive resins may be used as the structural material. The dielectric properties of the resin-based material will have a direct effect upon the final electrical performance of the conductively doped resin-based material. Many different dielectric properties are possible depending on the chemical makeup and/or arrangement, such as linking, cross-linking or the like, of the polymer, co-polymer, monomer, ter-polymer, or homo-polymer material. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material doped with micron conductive powders, micron conductive fibers, or in combination thereof can be molded, using conventional molding methods such as injection molding or over-molding, or extrusion to create desired shapes and sizes. The molded conductively doped resin-based materials can also be stamped, cut or milled as desired to form create the desired shapes and form factor(s). The doping composition and directionality associated with the micron conductors within the doped base resins can affect the electrical and structural characteristics of the articles and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming articles that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductively doped resin-based material may also be formed into a prepreg laminate, cloth, or webbing. A laminate, cloth, or webbing of the conductively doped resin-based material is first homogenized with a resin-based material. In various embodiments, the conductively doped resin-based material is dipped, coated, sprayed, and/or extruded with resin-based material to cause the laminate, cloth, or webbing to adhere together in a prepreg grouping that is easy to handle. This prepreg is placed, or laid up, onto a form and is then heated to form a permanent bond. In another embodiment, the prepreg is laid up onto the impregnating resin while the resin is still wet and is then cured by heating or other means. In another embodiment, the wet lay-up is performed by laminating the conductively doped resin-based prepreg over a honeycomb structure. In another embodiment, the honeycomb structure is made from conductively doped, resin-based material. In yet another embodiment, a wet prepreg is formed by spraying, dipping, or coating the conductively doped resin-based material laminate, cloth, or webbing in high temperature capable paint.

Prior art carbon fiber and resin-based composites are found to display unpredictable points of failure. In carbon fiber systems there is little if any elongation of the structure. By comparison, in the present invention, the conductively doped resin-based material, even if formed with carbon fiber or metal plated carbon fiber, displays greater strength of the mechanical structure due to the substantial homogenization of the fiber created by the moldable capsules. As a result a structure formed of the conductively doped resin-based material of the present invention will maintain structurally even if crushed while a comparable carbon fiber composite will break into pieces.

The conductively doped resin-based material of the present invention can be made resistant to corrosion and/or metal electrolysis by selecting micron conductive fiber and/or micron conductive powder dopants and base resins that are resistant to corrosion and/or metal electrolysis. For example, if a corrosion/electrolysis resistant base resin is combined with fibers/powders or in combination of such as stainless steel fiber, inert chemical treated coupling agent warding against corrosive fibers such as copper, silver and gold and or carbon fibers/powders, then corrosion and/or metal electrolysis resistant conductively doped resin-based material is achieved. Another additional and important feature of the present invention is that the conductively doped resin-based material of the present invention may be made flame retardant. Selection of a flame-retardant (FR) base resin material allows the resulting product to exhibit flame retardant capability. This is especially important in applications as described herein.

The substantially homogeneous mixing of micron conductive fiber and/or micron conductive powder and base resin described in the present invention may also be described as doping. That is, the substantially homogeneous mixing transforms a typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder within a base resin.

As an additional and important feature of the present invention, the molded conductor doped resin-based material exhibits excellent thermal dissipation characteristics. Therefore, articles manufactured from the molded conductor doped resin-based material can provide added thermal dissipation capabilities to the application. For example, heat can be dissipated from electrical devices physically and/or electrically connected to an article of the present invention.

As a significant advantage of the present invention, articles constructed of the conductively doped resin-based material can be easily interfaced to an electrical circuit or grounded. In one embodiment, a wire can be attached to conductively doped resin-based articles via a screw that is fastened to the article. For example, a simple sheet-metal type, self tapping screw can, when fastened to the material, can achieve excellent electrical connectivity via the conductive matrix of the conductively doped resin-based material. To facilitate this approach a boss may be molded as part of the conductively doped resin-based material to accommodate such a screw. Alternatively, if a solderable screw material, such as copper, is used, then a wire can be soldered to the screw is embedded into the conductively doped resin-based material. In another embodiment, the conductively doped resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the article and a grounding wire.

Where a metal layer is formed over the surface of the conductively doped resin-based material, any of several techniques may be used to form this metal layer. This metal layer may be used for visual enhancement of the molded conductively doped resin-based material article or to otherwise alter performance properties. Well-known techniques, such as electroless metal plating, electro plating, electrolytic metal plating, sputtering, metal vapor deposition, metallic painting, or the like, may be applied to the formation of this metal layer. If metal plating is used, then the resin-based structural material of the conductively doped, resin-based material is one that can be metal plated. There are many of the polymer resins that can be plated with metal layers. For example, GE Plastics, SUPEC, VALOX, ULTEM, CYCOLAC, UGIKRAL, STYRON, CYCOLOY are a few resin-based materials that can be metal plated. Electroless plating is typically a multiple-stage chemical process where, for example, a thin copper layer is first deposited to form a conductive layer. This conductive layer is then used as an electrode for the subsequent plating of a thicker metal layer.

A typical metal deposition process for forming a metal layer onto the conductively doped resin-based material is vacuum metallization. Vacuum metallization is the process where a metal layer, such as aluminum, is deposited on the conductively doped resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductively doped resin-based material of the present invention facilitates the use of extremely efficient, electrostatic painting techniques.

The conductively doped resin-based materials can be contacted in any of several ways. In one embodiment, a pin is embedded into the conductively doped resin-based material by insert molding, ultrasonic welding, pressing, or other means. A connection with a metal wire can easily be made to this pin and results in excellent contact to the conductively doped resin-based material conductive matrix. In another embodiment, a hole is formed in to the conductively doped resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductively doped resin-based material. In this case, a hole is formed in the conductively doped resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldered.

Another method to provide connectivity to the conductively doped resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductively doped resin-based material at the location of the applied solderable ink. Many other types of solderable inks can be used to provide this solderable surface onto the conductively doped resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductively doped resin-based material may be formed of the present invention to create a magnetic or magnetizable form of the material. Ferromagnetic micron conductive fibers and/or ferromagnetic conductive powders are substantially homogenized with the base resin. Ferrite materials and/or rare earth magnetic materials are added as a conductive doping to the base resin. With the substantially homogeneous mixing of the ferromagnetic micron conductive fibers and/or micron conductive powders, the ferromagnetic conductively doped resin-based material is able to produce an excellent low cost, low weight, high aspect ratio magnetize-able item. The magnets and magnetic devices of the present invention can be magnetized during or after the molding process. Adjusting the doping levels and or dopants of ferromagnetic micron conductive fibers and/or ferromagnetic micron conductive powders that are homogenized within the base resin can control the magnetic strength of the magnets and magnetic devices. By increasing the aspect ratio of the ferromagnetic doping, the strength of the magnet or magnetic devices can be substantially increased. The substantially homogenous mixing of the conductive fibers/powders or in combinations there of allows for a substantial amount of dopants to be added to the base resin without causing the structural integrity of the item to decline mechanically. The ferromagnetic conductively doped resin-based magnets display outstanding physical properties of the base resin, including flexibility, moldability, strength, and resistance to environmental corrosion, along with superior magnetic ability. In addition, the unique ferromagnetic conductively doped resin-based material facilitates formation of items that exhibit superior thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fibers/powders or combinations there of in a cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductively doped resin-based material may be magnetized, after molding, by exposing the molded article to a strong magnetic field. Alternatively, a strong magnetic field may be used to magnetize the ferromagnetic conductively doped resin-based material during the molding process.

The ferromagnetic conductively doped is in the form of fiber, powder, or a combination of fiber and powder. The micron conductive powder may be metal fiber or metal plated fiber or powders. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials. A ferromagnetic conductive doping may be combined with a non-ferromagnetic conductive doping to form a conductively doped resin-based material that combines excellent conductive qualities with magnetic capabilities.

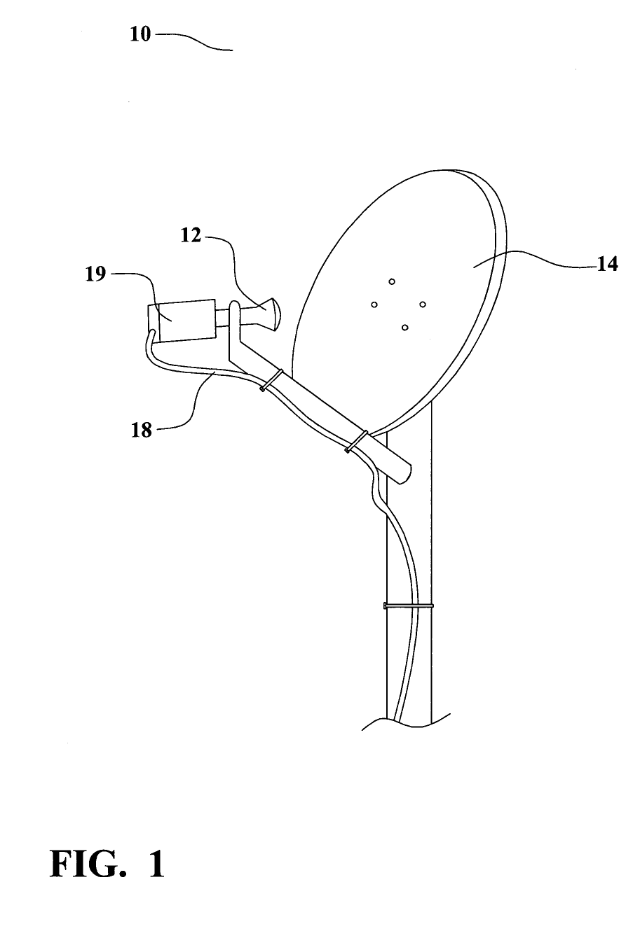

In the present invention, the conductively doped resin-based material is applied to the formation of satellite antenna devices and components. Referring now to FIG. 1, an embodiment of the present invention is illustrated. A satellite antenna device 10 is shown. The satellite dish 10 is of a type useful for transmitting or receiving, for example, satellite television, radio, or other digital data communications. Any component, or several components, of the satellite antenna 10 comprise the conductively doped resin-based material of the present invention. The satellite antenna 10 comprises a reflector 14, a feed horn 12, a low-noise block converter (LNB) 19, and a signal cable 18. In various embodiments, any, several, or all of these components comprise the conductively doped resin-based material described herein.

In one embodiment, the reflector 14, or dish, comprises the conductively doped resin-based material. In some embodiments, the reflector 14 is a parabolic-shaped dish. The feed horn 12 is centered in the axis of the dish. In other embodiments, the reflector is a small oval subsection of a larger parabolic shape, and the feed horn 12 is offset from the center of the dish 14 to form an offset-fed antenna. In one embodiment, the conductively doped resin-based reflector 14 is plated or coated with a metal layer. The metal layer increases reflection of incident electromagnetic energy resulting in focusing of incoming energy toward the feed horn 12 or transmission of energy from the feed horn 12 outwards in the direction of the axis of the dish 14. In another embodiment the reflector 14 is formed of conductively doped resin-based material that is painted with a conductive paint. The conductively doped resin-based material is light weight and easily molded into very precise shapes to form the reflector. The reflector provides a tight focusing of the incoming electromagnetic energy into the feed horn 12. The conductively doped resin-based reflector 14 also exhibits excellent dimensional stability over temperature and excellent resistance to corrosion. In another embodiment, the reflector 14 comprises a conductively doped resin-based material having a base-resin and conductive loading combination optimized for maximum reflection and minimum absorption of microwave energy.

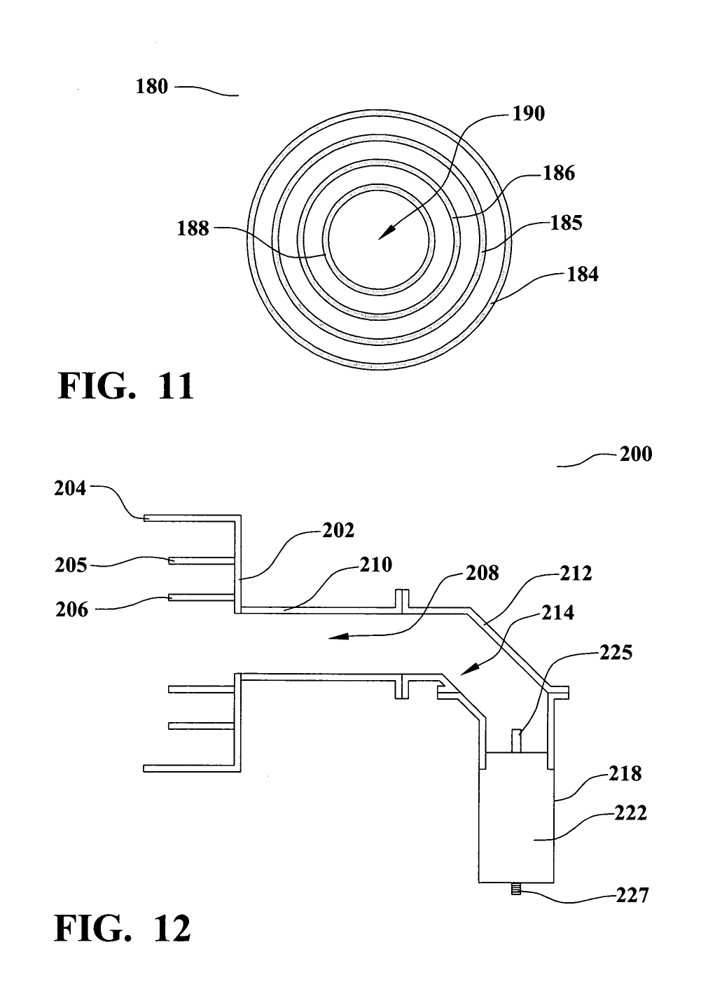

In one embodiment a feed horn 12 is placed at the focus point of the reflector 14. In a receiving antenna system, the feed horn 12 is used to further focus the cloud of electromagnetic energy from the reflector 14. The feed horn 12 also serves to exclude energy from other sources, such as ground noise, from being transmitted toward a receiving antenna probe in a low-noise block converter 19. Referring now to FIG. 11 an end view of a feed horn 180 is shown. In this embodiment, called a scalar feed horn, the feed horn 180 comprises a series of circular rings 184, 185, and 186 that collect and conduct an electromagnetic signal toward a central waveguide 188. As a result, electromagnetic energy is focused to the inner portion 190 of the waveguide 188. In one embodiment the feed horn 180 is formed of the conductively doped resin-based material. In another embodiment, the circular rings 184, 185, and 186 are formed of the conductively doped, resin-based material. In another embodiment, the central waveguide 188 is formed of the conductively doped, resin-based material. In other embodiments, the conductively doped, resin-based material is metal plated or metal coated to enhance the reflectivity of the feed horn 180. In yet other embodiments the feed horn 180 is formed of conductively doped resin-based material that is painted with a conductive paint to alter the reflectivity. In another embodiment, the feed horn 180 comprises a conductively doped resin-based material having a base-resin and conductive loading combination optimized for maximum reflection and minimum absorption of microwave energy. The conductively doped resin-based material is light weight and easily molded to form feed horns 180 with very precise shapes.

Referring again to FIG. 1, a low-noise block converter (LNB) 19 is included in this embodiment. The LNB 19 comprises an antenna, typically called an antenna probe where the satellite device 10 is used for receiving signals, and a LNB circuit. Satellites signals are typically transmitted in the microwave frequency bands. Microwave signals are well suited for long distance transmission through the Earth's atmosphere with little signal data loss. However, once the transmission is completed, maintaining the operating signal in the microwave range is very problematic. Microwave signal frequencies can exceed the bandwidth capabilities of signal cables 18 that are used to transmit the received signal from the satellite antenna device 10 to an electronic processing device such as a television decoder. Excessive signal losses occur in the cable 18. It is therefore advantageous to down-convert the satellite signal from the microwave range to the radio frequency (RF) range prior to transmission through a physical cable 18. The LNB circuit 19 comprises an antenna probe to convert incoming electromagnetic energy into electrical voltage and current, a signal processing circuit to down-convert the signal carrier from the microwave to the RF range, and a driver to feed this down-converted signal onto a cable 18.

Referring now to FIG. 12, an embodiment 200 of an assembly combining a feed horn 202, waveguides 210 and 212, and a LNB 218 for a satellite signal reception is shown in cross-sectional view. The feed horn 202 comprises circular rings 204, 205, and 206 to focus electromagnetic energy into the waveguides 210 and 212. The waveguides 210 and 212 guide electromagnetic energy through channels 208 and 214 where the energy is presented to an antenna probe 225 of a LNB 218. The LNB 218 uses the super heterodyne principle to convert a microwave signal carrier into an intermediate frequency (or IF) carrier. The IF is then transmitted to a satellite receiver via a wire or cable. The IF signal maintains a high signal-to-noise ratio in the cable since it is better matched to the bandwidth of the cable.

In one embodiment, the waveguides 210 and 212 comprise conductively doped, resin-based material. In other embodiments, the conductively doped, resin-based material is metal plated or metal coated to enhance the reflectivity of the waveguides 210 and 212. In yet other embodiments the waveguides are formed of conductively doped resin-based material that is painted with a conductive paint to alter the reflectivity. In another embodiment, the waveguides comprises a conductively doped resin-based material having a base-resin and conductive doping combination optimized for maximum reflection and minimum absorption of microwave energy. The conductively doped resin-based material is light weight and easily molded to form waveguides of very precise shapes.

In one embodiment, the antenna probe 225 comprises the conductively doped resin-based material of the present invention. A wide variety of antenna structures are easily formed of the conductively doped resin-based material of the present invention. Monopole, dipole, geometric shapes, 2D, 3D, 4D, 5D, isotropic structures, planar, inverted F, PIFA, and the like, are all within the scope of the present invention. The antenna design can be molded by, for example, injection molding. The molded antenna shape determines the resonant frequency response of the antenna. Antenna structures and devices formed of the conductively doped resin-based material of the present invention have been found to be extremely efficient in receiving and transmitting radio waves across a wide frequency spectrum. In other embodiments, the conductively doped, resin-based material is selectively metal plated or metal coated as a means of tuning the antenna probe 225. In yet other embodiments the antenna probe 225 is formed of conductively doped resin-based material that is painted with a conductive paint to tune the antenna performance. In another embodiment, the antenna probe comprises a conductively doped resin-based material having a base-resin and conductive doping combination optimized for maximum transmission of microwave energy. The conductively doped resin-based material is light weight and easily molded to form antenna probes with very precise shapes.

In one embodiment, the case 222 of the LNB is formed of the conductively doped resin-based material of the present invention. The conductively doped resin-based material absorbs electromagnetic energy to protect the circuitry inside the case from external electromagnetic interference and to reduce electromagnetic emissions from the LNB 218. In other embodiments, the conductively doped, resin-based material is selectively metal plated or metal coated. In yet other embodiments the LNB case 222 is formed of conductively doped resin-based material that is painted with a conductive paint. The conductively doped resin-based material of the present invention is structurally strong, low in weight, corrosion resistant, durable, and moisture impervious. The conductively doped, resin-based material case efficiently conducts thermal energy away from the LNB circuit to improve performance. The conductively doped resin-based material is light weight and easily molded to form cases with very precise shapes.

The LNB circuit 218 drives the down-converted signal through an output connector 227 that is coupled to a cable. In one embodiment, the connector 227 comprises the conductively doped, resin-based material of the present invention. In other embodiments, the conductively doped, resin-based material is selectively metal plated or metal coated. In yet other embodiments the connector 227 is formed of conductively doped resin-based material that is painted with a conductive paint. The conductively doped resin-based material is light weight and easily molded to form connectors with very precise shapes.

Referring again to FIG. 1, in one embodiment, a cable 18 comprises a coaxial cable with a center conductive core formed from the conductively doped resin-based material. In another embodiment the cable 18 is coaxial cable with a center conductive core of metal. In yet another embodiment the cable 18 is a non-coaxial wire or cable with a center conductive core formed of the conductively doped resin-based material. In yet another embodiment the cable 18 is a non-coaxial wire or cable with a center conductive core of metal and an outer shield of the conductively doped, resin-based material. The conductively doped resin-based material is light weight and easily molded to form cables with very precise shapes.

It is understood that embodiments of the present invention may comprises any, or all, of the components described. For example, a satellite antenna device having a reflector and an antenna probe, but no feed horn, may be formed. Similarly, a satellite antenna device may be formed with a feed horn but no waveguide. In other embodiments, wiring harnesses, switches, lighting components, electromagnetic absorbing components, connectors, circuit boards, heat sinks, and the like, are formed of the conductively doped resin-based material of the present invention.

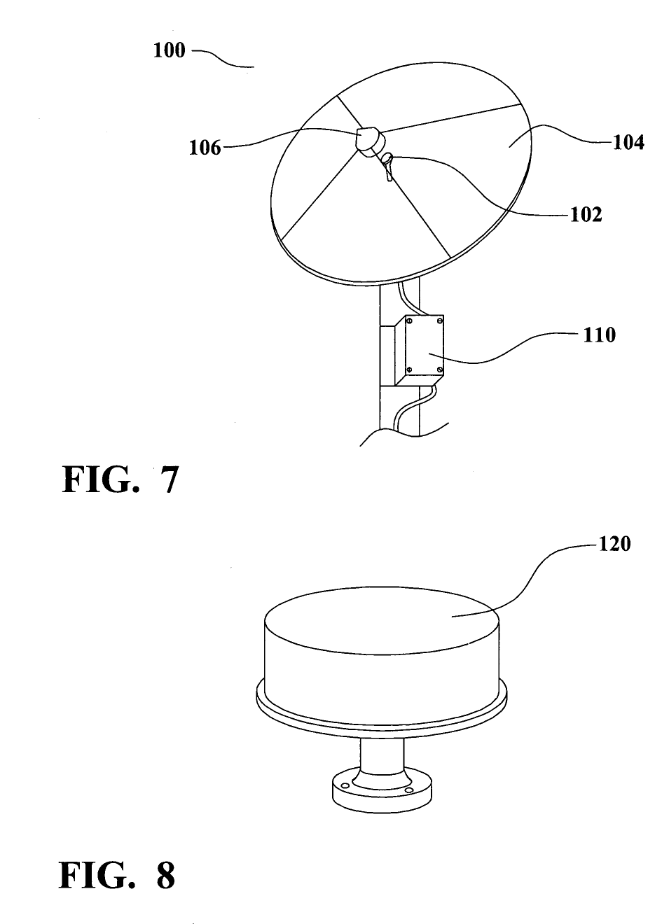

Referring now to FIG. 7, another satellite antenna device is illustrated. A Cassegrain satellite antenna 100 is shown. A Cassegrain antenna utilizes a double reflector system and operates on the same basic principle as a Cassegrain optical telescope. A parabolic reflector 104 reflects incident electromagnetic energy and focuses this reflected energy onto a second, smaller reflector 106. This second reflector 106 then reflects and further focuses the electromagnetic energy toward a feed horn 102 with an antenna mounted therein. Satellite antennas of this design tend to be more efficient because the opening of the feed horn 102 is directed toward the sky and is, therefore, less susceptible to thermal noise generated from the earth.

In various embodiments, any component, or several components, of the satellite antenna 100 comprise the conductively doped resin-based material of the present invention. In one embodiment, the first reflector 104 comprises the conductively doped resin-based material. In another embodiment, the second reflector 106 comprises the conductively doped, resin-based material. In another embodiment, both reflectors comprise the conductively doped, resin-based material. In one embodiment, the conductively doped resin-based material is plated or coated with a metal layer. The metal layer increases reflection of incident electromagnetic energy resulting in focusing of incoming energy or transmission of energy outwards in the direction of the axis of the antenna 100. In another embodiment the conductively doped resin-based material is painted with a conductive paint. The conductively doped resin-based material is light weight and easily molded to form reflectors 104 and 106 with very precise shapes. The reflectors provide a tight focusing of electromagnetic energy. The conductively doped resin-based reflectors also exhibit excellent dimensional stability over temperature and excellent resistance to corrosion. In another embodiment, the conductively doped resin-based material comprises a base-resin and conductive doping combination optimized for maximum reflection and minimum absorption of microwave energy.

In one embodiment a feed horn 102 is formed of the conductively doped resin-based material. In other embodiments, the conductively doped, resin-based material is metal plated or metal coated to enhance the reflectivity of the feed horn 102. In yet other embodiments the feed horn 102 is formed of conductively doped resin-based material that is painted with a conductive paint to alter the reflectivity. In another embodiment, the feed horn 102 comprises a conductively doped resin-based material having a base-resin and conductive doping combination optimized for maximum reflection and minimum absorption of microwave energy.

In one embodiment, a waveguide comprises the conductively doped, resin-based material. In other embodiments, the conductively doped, resin-based material is metal plated or metal coated to enhance the reflectivity of the waveguide. In yet other embodiments the conductively doped resin-based material is painted with a conductive paint to alter the reflectivity. In another embodiment, a waveguide comprises a conductively doped resin-based material having a base-resin and conductive doping combination optimized for maximum reflection and minimum absorption of microwave energy.

A LNB circuit comprises an antenna probe to convert incoming focused electromagnetic energy into electrical voltage and current, a signal processing circuit to down-convert the signal carrier from the microwave to the RF range, and a driver to feed this down-converted signal onto a cable. In one embodiment, an antenna probe comprises the conductively doped resin-based material of the present invention. A wide variety of antenna structures are easily formed of the conductively doped resin-based material of the present invention. Monopole, dipole, geometric shapes, 2D, 3D, 4D, 5D, isotropic structures, planar, inverted F, PIFA, and the like, are all within the scope of the present invention. The antenna design can be molded by, for example, injection molding. The molded antenna shape determines the resonant frequency response of the antenna. Antenna structures and devices formed of the conductively doped resin-based material of the present invention have been found to be extremely efficient in receiving and transmitting radio waves across a wide frequency spectrum. In other embodiments, the conductively doped, resin-based material is selectively metal plated or metal coated as a means of tuning an antenna probe. In yet other embodiments an antenna probe is formed of conductively doped resin-based material that is painted with a conductive paint to tune the antenna performance. In another embodiment, the antenna probe comprises a conductively doped resin-based material having a base-resin and conductive doping combination optimized for maximum transmission of microwave energy.

In one embodiment, the case of the LNB is formed of the conductively doped resin-based material of the present invention. The conductively doped resin-based material absorbs electromagnetic energy to protect the circuitry inside the case from external electromagnetic interference and to reduce electromagnetic emissions from the LNB. In other embodiments, the conductively doped, resin-based material is selectively metal plated or metal coated. In yet other embodiments the LNB case is formed of conductively doped resin-based material that is painted with a conductive paint. The conductively doped resin-based material of the present invention is structurally strong, low in weight, corrosion resistant, durable, and moisture impervious. The conductively doped, resin-based material case efficiently conducts thermal energy away from the LNB circuit to improve performance.

The LNB circuit drives the down-converted signal through an output connector that is coupled to a cable. In one embodiment, the connector comprises conductively doped, resin-based material of the present invention. In other embodiments, the conductively doped, resin-based material is selectively metal plated or metal coated. In yet other embodiments a connector is formed of conductively doped resin-based material that is painted with a conductive paint. In one embodiment, a coaxial cable with a center conductive core is formed from the conductively doped resin-based material. In another embodiment a coaxial cable has a center conductive core of metal. In yet another embodiment a cable has a non-coaxial wire or cable with a center conductive core formed of the conductively doped resin-based material. In yet another embodiment a cable 18 has a non-coaxial wire or cable with a center conductive core of metal and an outer shield of the conductively doped, resin-based material.

It is understood that embodiments of the present invention may comprises any, or all, of the components described. For example, a satellite antenna device having a reflector and an antenna probe, but no feed horn, may be formed. Similarly, a satellite antenna device may be formed with a feed horn but no waveguide. In other embodiments, wiring harnesses, switches, lighting components, electromagnetic absorbing components, connectors, circuit boards, heat sinks, and the like, are formed of the conductively doped resin-based material of the present invention.

Referring now to FIG. 8, an embodiment of a marine satellite radio antenna 120 is shown. In this embodiment the marine satellite radio antenna 120 comprises the conductively doped resin-based material of the present invention. A wide variety of antenna structures are easily formed of the conductively doped resin-based material of the present invention. Monopole, dipole, geometric shapes, 2D, 3D, 4D, 5D, isotropic structures, planar, inverted F, PIFA, and the like, are all within the scope of the present invention. The antenna design can be molded by, for example, injection molding. The molded antenna shape determines the resonant frequency response of the antenna.

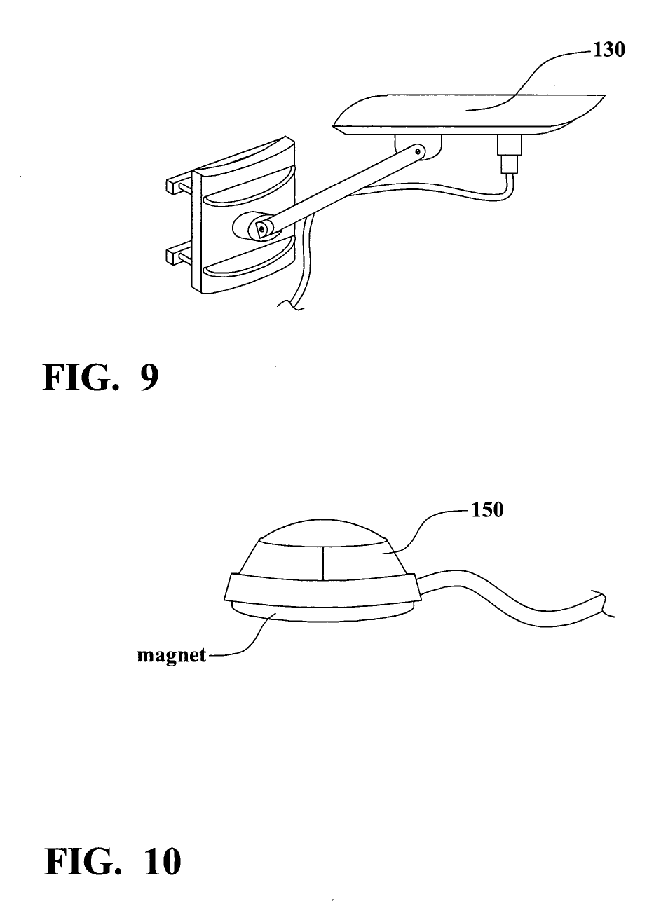

Referring now to FIG. 9, an embodiment an external satellite radio antenna 130 is shown. In this embodiment the home external satellite radio antenna 130 comprises the conductively doped resin-based material of the present invention. A wide variety of antenna structures are easily formed of the conductively doped resin-based material of the present invention. Monopole, dipole, geometric shapes, 2D, 3D, 4D, 5D, isotropic structures,-planar, inverted F, PIFA, and the like, are all within the scope of the present invention. The antenna design can be molded by, for example, injection molding. The molded antenna shape determines the resonant frequency response of the antenna.

Referring now to FIG. 10, an embodiment of a magnetic-mount automobile satellite radio antenna 150 is shown. In this embodiment the magnetic-mount automobile satellite radio antenna 150 comprises the conductively doped resin-based material of the present invention. A wide variety of antenna structures are easily formed of the conductively doped resin-based material of the present invention. Monopole, dipole, geometric shapes, 2D, 3D, 4D, 5D, isotropic structures, planar, inverted F, PIFA, and the like, are all within the scope of the present invention. The antenna design can be molded by, for example, injection molding. The molded antenna shape determines the resonant frequency response of the antenna. In one embodiment, a magnetic mounting base for the antenna 150 is formed of the conductively doped, resin-based material where a ferromagnetic material is used for the doping.

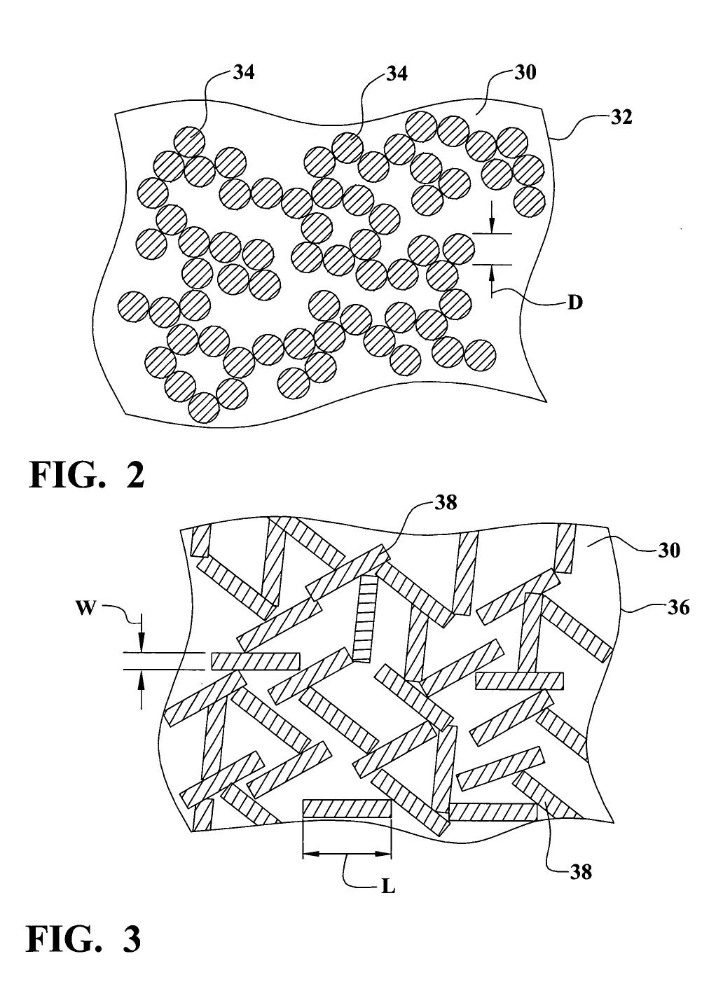

The conductively doped resin-based material typically comprises a micron powder(s) of conductor particles and/or in combination of micron fiber(s) substantially homogenized within a base resin host. FIG. 2 shows a cross section view of an example of conductively doped resin-based material 32 having powder of conductor particles 34 in a base resin host 30. In this example the diameter D of the conductor particles 34 in the powder is between about 3 and 12 microns.

FIG. 3 shows a cross section view of an example of conductively doped resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The micron conductive fibers 38 may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

These conductor particles and/or fibers are substantially homogenized within a base resin. As previously mentioned, the conductively doped resin-based materials have a sheet resistance of less than about 5 to more than about 25 ohms per square, though other values can be achieved by varying the doping parameters and/or resin selection. To realize this sheet resistance the weight of the conductor material comprises between about 20% and about 50% of the total weight of the conductively doped resin-based material. More preferably, the weight of the conductive material comprises between about 20% and about 40% of the total weight of the conductively doped resin-based material. More preferably yet, the weight of the conductive material comprises between about 25% and about 35% of the total weight of the conductively doped resin-based material. Still more preferably yet, the weight of the conductive material comprises about 30% of the total weight of the conductively doped resin-based material. Stainless Steel Fiber of 6-12 micron in diameter and lengths of 4-6 mm and comprising, by weight, about 30% of the total weight of the conductively doped resin-based material will produce a very highly conductive parameter, efficient within any EMF, thermal, acoustic, or electronic spectrum.

In yet another preferred embodiment of the present invention, the conductive doping is determined using a volume percentage. In a most preferred embodiment, the conductive doping comprises a volume of between about 4% and about 10% of the total volume of the conductively doped resin-based material. In a less preferred embodiment, the conductive doping comprises a volume of between about 1% and about 50% of the total volume of the conductively doped resin-based material though the properties of the base resin may be impacted by high percent volume doping.

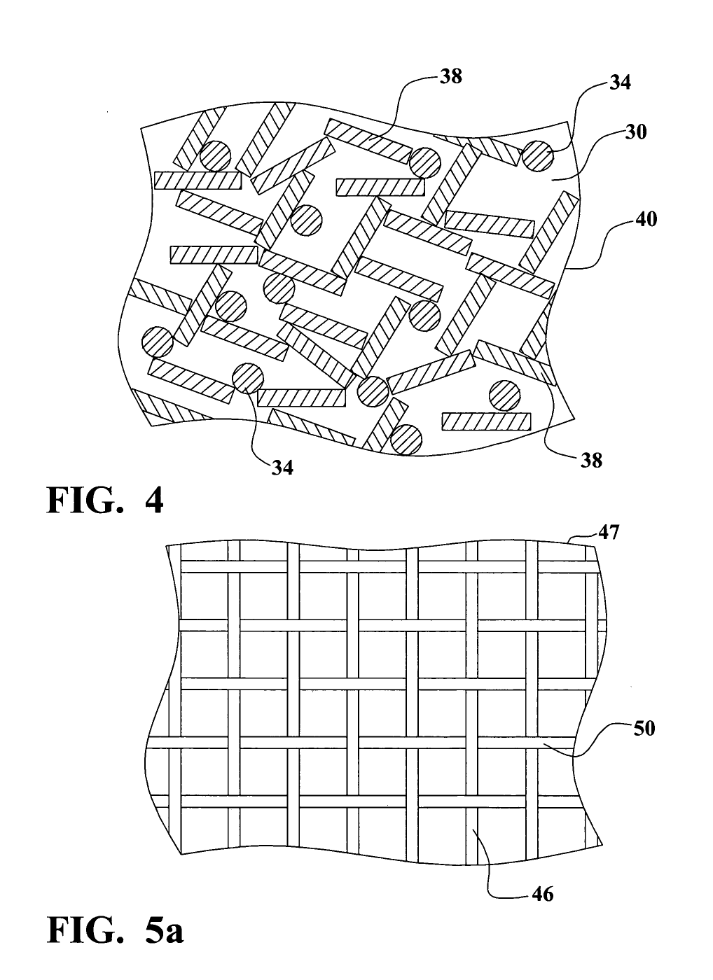

Referring now to FIG. 4, another preferred embodiment of the present invention is illustrated where the conductive materials comprise a combination of both conductive powders 34 and micron conductive fibers 38 substantially homogenized together within the resin base 30 during a molding process.

Referring now to FIGS. 5a and 5b, a preferred composition of the conductively doped, resin-based material is illustrated. The conductively doped resin-based material can be formed into fibers or textiles that are then woven or webbed into a conductive fabric. The conductively doped resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

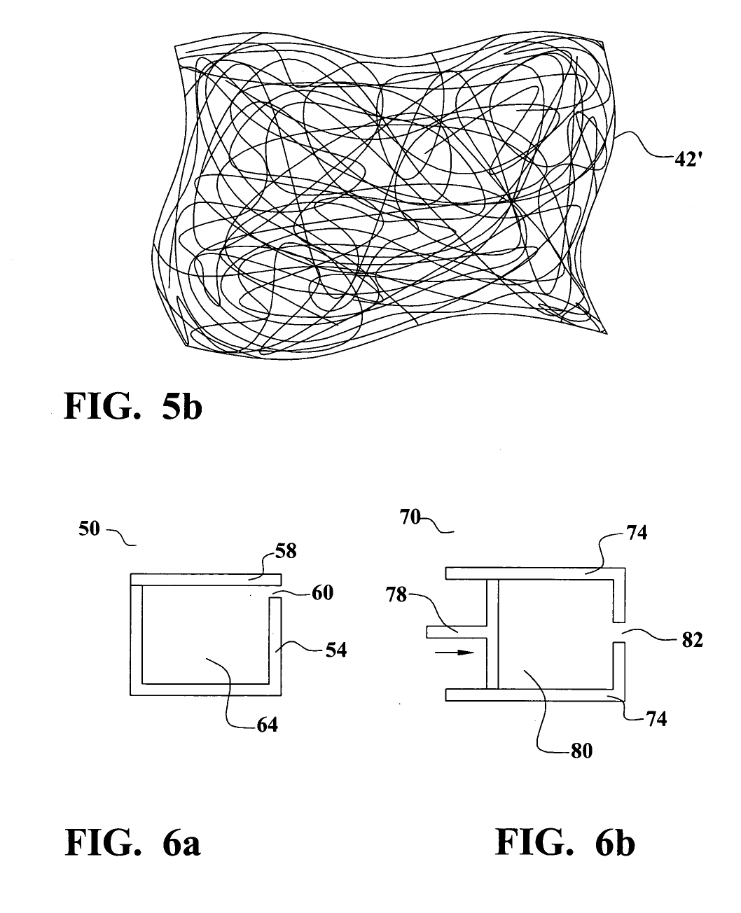

Articles formed from conductively doped resin-based materials can be formed or molded in a number of different ways including injection molding, extrusion, calendaring, compression molding, thermoset molding, or chemically induced molding or forming. FIG. 6a shows a simplified schematic diagram of an injection mold showing a lower portion 54 and upper portion 58 of the mold 50. Conductively doped resin-based material is injected into the mold cavity 64 through an injection opening 60 and then the substantially homogenized conductive material cures by thermal reaction. The upper portion 58 and lower portion 54 of the mold are then separated or parted and the articles are removed.

FIG. 6b shows a simplified schematic diagram of an extruder 70 for forming articles using extrusion. Conductively doped resin-based material(s) is placed in the hopper 80 of the extrusion unit 74. A piston, screw, press or other means 78 is then used to force thermally molten, chemically-induced compression, or thermoset curing conductively doped resin-based material through an extrusion opening 82 which shapes the thermally molten curing or chemically induced cured conductively doped resin-based material to the desired shape. The conductively doped resin-based material is then fully cured by chemical reaction or thermal reaction to a hardened or pliable state and is ready for use. Thermoplastic or thermosetting resin-based materials and associated processes may be used in molding the conductively doped resin-based articles of the present invention.

The advantages of the present invention may now be summarized. An effective satellite communications antenna is achieved. A method to form a satellite communications device is achieved. The satellite communications antenna is molded of conductively doped resin-based materials. The electromagnetic, thermal, acoustical, and electrical characteristics of the satellite antenna device can be altered or the visual characteristics can be altered by forming a metal layer over the conductively doped resin-based material. A method to fabricate a satellite communications antenna from a fabric form of conductively doped resin-based material is achieved. The satellite communications antenna is formed from a low density material that, nonetheless, exhibits excellent structural strength and excellent antenna performance. The satellite communications antenna exhibits excellent corrosion resistance. A reflector for a satellite communications antenna is achieved. A feed horn for a satellite communications antenna is achieved. A waveguide for a satellite communications antenna is achieved. A low-noise band circuit for a satellite communications antenna is achieved.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the scope of the invention.

What is claimed is:

1. A satellite antenna device comprising:
a reflector; and
an antenna mounted near said reflector such that electromagnetic energy is transferred between said reflector and said antenna wherein said antenna comprises conductively doped, resin-based material comprising conductive materials in a base resin host.

2. The device according to claim 1 wherein the percent by weight of said conductive materials is between about 20% and about 50% of the total weight of said conductively doped resin-based material.

3. The device according to claim 1 wherein said conductive materials comprise micron conductive fiber.

4. The device according to claim 3 wherein said micron conductive fiber is metal.

5. The device according to claim 3 wherein said micron conductive fiber is a non-metal core with a metal layer plated thereon.

6. The device according to claim 3 wherein said micron conductive fiber further comprises a chemically inert coupling agent overlying said fiber.

7. The device according to claim 3 wherein said conductive materials further comprise micron conductive powder.

8. The device according to claim 7 wherein said micron conductive powder is metal.

9. The device according to claim 7 wherein said micron conductive powder is a non-metal core with a metal layer plated thereon.

10. The device according to claim 1 wherein said reflector comprises said conductively doped resin-based material.

11. The device according to claim 10 wherein said reflector is metal plated.

12. The device according to claim 1 further comprising a wave guide mounted between said reflector and said antenna.

13. The device according to claim 12 wherein said wave guide comprises said conductively doped resin-based material.

14. The device according to claim 13 wherein said wave guide is metal plated.

15. The device according to claim 13 wherein said wave guide is shaped as a feed horn.

16. The device according to claim 1 wherein said conductive material comprises ferromagnetic material.

17. A satellite antenna device comprising:
a reflector; and
an antenna mounted near said reflector such that electromagnetic energy is transferred between said reflector and said antenna wherein said antenna and said reflector comprise conductively doped, resin-based material comprising micron conductive fiber in a base resin host.

18. The device according to claim 17 wherein said micron conductive fiber is metal.

19. The device according to claim 17 wherein said micron conductive fiber is a non-metal core with a metal layer plated thereon.

20. The device according to claim 17 a wherein said micron conductive fiber further comprises a chemically inert coupling agent overlying said fiber.

21. The device according to claim 17 further comprising micron conductive powder.

22. The device according to claim 21 wherein said micron conductive powder is metal.

23. The device according to claim 21 wherein said micron conductive powder is a non-metal core with a metal layer plated thereon.

24. The device according to claim 17 wherein said reflector is metal plated.

25. The device according to claim 17 further comprising a wave guide mounted between said reflector and said antenna.

26. The device according to claim 25 wherein said wave guide comprises said conductively doped resin-based material.

27. The device according to claim 25 wherein said wave guide is metal plated.

28. The device according to claim 25 wherein said wave guide is shaped as a feed horn.

29. The device according to claim 17 further comprising a magnetic mounting base comprising a second conductively doped, resin-based material comprising conductive materials in a base resin host wherein said conductive materials comprise ferromagnetic material.

30. A method to form a satellite antenna device, said method comprising:
providing a conductively doped, resin-based material comprising conductive materials in a resin-based host;
molding said conductively doped, resin-based material into a satellite antenna device comprising:
a reflector; and
an antenna mounted near said reflector such that electromagnetic energy is transferred between said reflector and said antenna wherein said antenna comprises said conductively doped, resin-based material.

31. The method according to claim 30 wherein the percent by weight of said conductive materials is between about 20% and about 50% of the total weight of said conductively doped resin-based material.

32. The method according to claim 30 wherein said conductive materials comprise micron conductive fiber.

33. The method according to claim 30 wherein said conductive materials further comprise a combination of micron conductive fiber and micron conductive powder.

34. The method according to claim 30 wherein said conductive materials are metal.

35. The method according to claim 30 wherein said conductive materials are non-conductive materials with metal plating.

36. The method according to claim 30 wherein said step of molding comprises:
injecting said conductively doped, resin-based material into a mold;
curing said conductively doped, resin-based material; and
removing said satellite antenna device from said mold.

37. The method according to claim 30 wherein said step of molding comprises:
loading said conductively doped, resin-based material into a chamber;
extruding said conductively doped, resin-based material out of said chamber through a shaping outlet; and
curing said conductively doped, resin-based material to form said satellite antenna device.
